(19) United States
(12) Patent Application Publication
(10) Pub. No.: US 2010/0272953 A1
(43) Pub. Date: Oct. 28, 2010

(54) COOLED HYBRID STRUCTURE FOR GAS TURBINE ENGINE AND METHOD FOR THE FABRICATION THEREOF

(75) Inventors: Paul Yankowich, Phoenix, AZ (US); James Hadder, Scottsdale, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/431,547

(22) Filed: Apr. 28, 2009

(51) Int. Cl. B32B 3/24; B05D 3/12

(52) U.S. Cl. 428/138; 427/355

(57) ABSTRACT

A cooled hybrid structure is provided for deployment within a gas turbine engine. In one embodiment, the cooled hybrid structure includes a woven oxide fiber sheet and an insulative oxide coating. The woven oxide fiber sheet includes an outer cold wall and an inner hot wall, which is integrally woven with the outer cold wall and which cooperates therewith to define a plurality of elongated cooling channels extending within the woven oxide fiber sheet. A plurality of impingement apertures is formed through the outer cold wall and conducts airflow into the plurality of elongated cooling channels and against the inner hot wall to convectively cool the woven oxide fiber sheet. A plurality of effusion channels is formed through the inner hot wall and through the insulative oxide coating and conducts airflow through the insulative oxide coating to provide convective cooling thereof.

### STATEMENT REGARDING FEDERALLY SPONSORED RESEARCH OR DEVELOPMENT

This invention was made with Government support under Contract No. F33615-03-D-2355-0004 awarded by the U.S. Air Force. The Government has certain rights in this invention.

### TECHNICAL FIELD

The present invention relates generally to gas turbine engines and, more particularly, to a cooled hybrid structure, such as a combustor liner wall, suitable for deployment within a gas turbine engine.

### BACKGROUND

A generalized gas turbine engine (GTE) includes an intake section, a compressor section, a combustion section, a turbine section, and an exhaust section disposed in axial flow series. The compressor section includes one or more compressor stages, and the turbine section includes one or more air turbine stages each joined to a different compressor stage via a rotatable shaft or spool. During operation, the compressor stages rotate to compress air received from the intake section of the GTE. A first portion of the compressed air is directed into an annular combustor mounted within the combustion section, and a second portion of the air is directed through cooling channels that flow over and around the combustor. Within the combustion chamber, the compressed air is mixed with fuel and ignited. The air heats rapidly and exits each combustor chamber via an outlet provided through the combustor's downstream end. The air is received by at least one turbine nozzle, which is sealingly coupled to the combustor's downstream end. The turbine nozzle directs the air through the air turbines to drive the rotation of the air turbines, as well as the rotation of the spools and compressor stages coupled thereto. Finally, the air is expelled from the GTE's exhaust section. The power output of the GTE may be utilized in a variety of different manners, depending upon whether the GTE assumes the form of a turbofan, turboprop, turboshaft, or turbojet engine.

Gas turbine engines have been extensively engineered to improve performance characteristics while also providing a relatively long operational lifespan. One of the most direct manners in which the GTE performance may be improved is by increasing combustion temperatures. Higher combustion temperatures increase fuel efficiency, thrust-to-weight ratios, and various other measures of engine performance. However, high combustion temperatures may also result in premature structural compromise (e.g., structural break-down, thermomechanical fatigue, oxidation, creep, etc.) of structural components within a gas turbine engine, most notably the combustor liner walls. Therefore, to help reduce the operational temperature of the combustor liner walls relative to peak combustion temperatures, the interior of the combustor walls may be coated with a thermal insulation material. In addition, the combustor liner walls may be provided with structural features, such as impingement apertures and effusion channels, to help increase the effectiveness of convective cooling. This notwithstanding, further increases in the cooling efficiency of combustor liner walls, as well as other structural components included within gas turbine engine, are needed as GTE technology continues to advance and combustion temperatures continue to increase.

It is thus desirable to provide a cooled hybrid structure suitable for deployment within a gas turbine engine as a combustor liner wall (or other air-cooled structural component) that achieves highly effective convective cooling, minimizes head-induced structural compromise (e.g., thermomechanical fatigue, oxidation, creep etc.), and increases overall operational lifespan. Preferably, such a cooled hybrid structure would be relatively lightweight and environmentally durable. It would also be desirable to provide a method for fabricating such a cooled hybrid structure. Other desirable features and characteristics of the present invention will become apparent from the subsequent Detailed Description and the appended Claims, taken in conjunction with the accompanying Drawings and this Background.

### BRIEF SUMMARY

A cooled hybrid structure is provided for deployment within a gas turbine engine. In one embodiment, the cooled hybrid structure includes a woven oxide fiber sheet and an insulative oxide coating. The woven oxide fiber sheet includes an outer cold wall and an inner hot wall, which is integrally woven with the outer cold wall and which cooperates therewith to define a plurality of cooling channels extending within the woven oxide fiber sheet. A plurality of impingement apertures is formed through the outer cold wall and conducts airflow into the plurality of cooling channels and against the inner hot wall to convectively cool the woven oxide fiber sheet. A plurality of effusion channels is formed through the inner hot wall and through the insulative oxide coating and conducts airflow through the insulative oxide coating to provide convective cooling thereof.

A method for fabricating a cooled hybrid structure for deployment within a gas turbine engine is also provided. In one embodiment, the method includes the steps of: (i) forming a woven oxide fiber sheet having an outer cold wall, an inner hot wall, and a plurality elongated cooling channels extending within the woven oxide fiber sheet; (ii) applying an insulative oxide coating over the inner hot wall; and (iii) drilling a plurality of impingement apertures through the outer cold wall and a plurality of effusion channels through the inner hot wall and through the insulative oxide coating. The plurality of impingement apertures is configured to conduct airflow into the plurality of elongated cooling channels and against the inner hot wall to convectively cool the woven oxide fiber sheet, and the plurality of effusion channels is configured to conduct airflow through the insulative oxide coating to provide convective cooling thereof.

### BRIEF DESCRIPTION OF THE DRAWINGS

At least one example of the present invention will hereinafter be described in conjunction with the following figures, wherein like numerals denote like elements, and:

FIG. 1 is a generalized cross-sectional view of an upper portion of an exemplary gas turbine engine (GTE) combustor section including a combustion chamber generally defined by an inner liner wall and an outer liner wall;

FIG. 2 is a cross-sectional isometric view of a cooled hybrid structure in accordance with a first exemplary embodiment and suitable for employment within a GTE as, for example, the inner liner wall and/or the outer liner wall shown in FIG. 1;

FIG. 3 is a simplified cross-sectional view of the exemplary cooled hybrid structure shown in FIG. 2 illustrating one manner in which cooling airflow may be conducted through a plurality of impingement apertures and effusion channels provided through the cooled hybrid structure;

FIG. 4 is a cross-sectional isometric view of a cooled hybrid structure in accordance with a second exemplary embodiment and suitable for employment within a GTE as, for example, the inner liner wall and/or the outer liner wall shown in FIG. 1; and

FIG. 5 is a simplified cross-sectional view of the exemplary cooled hybrid structure shown in FIG. 4 illustrating one manner in which cooling airflow may be conducted through a plurality of impingement apertures and effusion channels provided through the cooled hybrid structure.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description. Although the following describes embodiments of the cooled hybrid structure particularly well-suited for utilization as a combustor liner wall, it is emphasized that embodiments of the cooled hybrid structure may also be utilized to form various other structural components of a gas turbine engine including, for example, turbine shrouds.

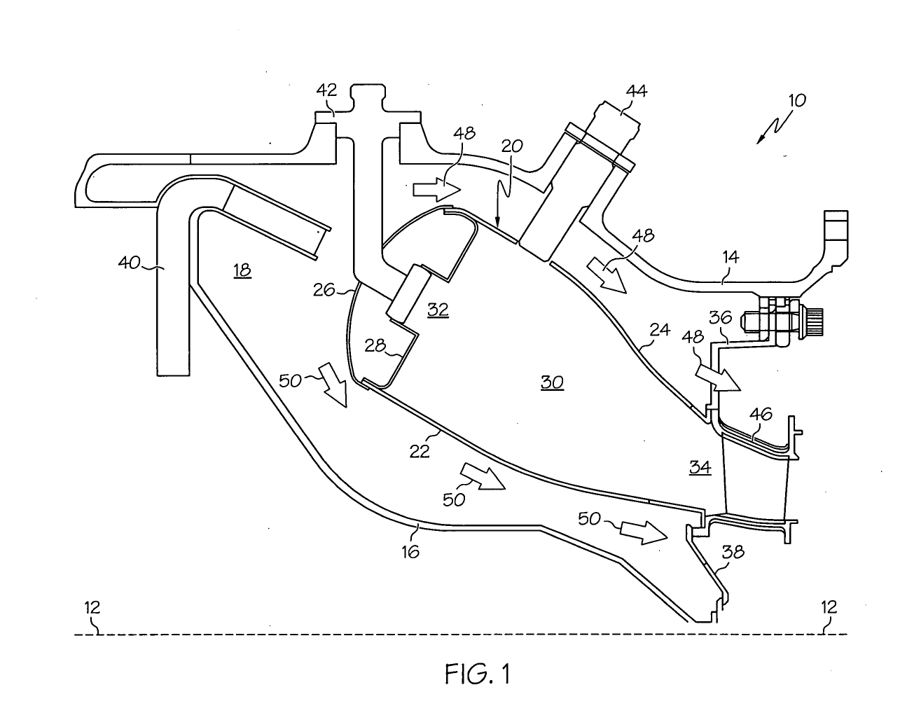

FIG. 1 is a generalized cross-sectional view of an exemplary combustion section 10 of a gas turbine engine (GTE). Only an upper portion of combustion section 10 is shown in FIG. 1 for clarity; as will be readily appreciated, combustion section 10 is generally radially symmetrical about the longitudinal axis of the GTE (represented in FIG. 1 by dashed centerline 12). Combustion section 10 includes an outer engine casing 14 and an inner engine casing 16, which cooperate to define a generally annular cavity 18 within combustion section 10. A combustor 20 is mounted within annular cavity 18. Combustor 20 includes an inner liner wall 22, an outer liner wall 24, a combustor dome shroud 26, and at least one carburetor assembly 28. Inner liner wall 22 and outer liner wall 24 each have a generally conical geometry and collectively define an annular combustion chamber 30 having an inlet 32 and an outlet 34. Carburetor assembly 28 is mounted within an upstream portion of combustion chamber 30 proximate inlet 32. Combustor dome shroud 26 is mounted to an external portion of inner liner wall 22 and outer liner wall 24 proximate inlet 32 and partially encloses inlet 32. In the illustrated example, the downstream portion of combustor 20, and specifically the trailing end of outer liner wall 24, is mounted to a first flange 36 extending radially inward from outer engine casing 14. Similarly, the downstream portion of combustor 20, and specifically the trailing end of inner liner wall 22, is mounted to a second flange 38 extending radially outward from inner engine casing 16.

With continued reference to FIG. 1, combustion section 10 further includes at least one diffuser 40 mounted through inner engine casing 16 upstream of combustor 20; at least one fuel injector 42 extending radially inward from outer engine casing 14 and received by carburetor assembly 28; and at least one igniter 44 extending radially inward from outer engine casing 14, through outer liner wall 24, and into combustion chamber 30. During operation, diffuser 40 directs compressed air received from the GTE's compressor section into generally annular cavity 18. A portion of the compressed air supplied by diffuser 40 flows through combustor dome shroud 26 and into carburetor assembly 28. Carburetor assembly 28 mixes the compressed air with fuel received from fuel injector 42 and introduces the resulting fuel-air mixture into combustion chamber 30. Within combustion chamber 30, the fuel-air mixture is ignited by igniter 44 to initiate combustion. The air heats rapidly, exits combustion chamber 30 via outlet 34, and flows into at least one turbine nozzle 46 disposed downstream of combustion section 10. Turbine nozzles 46 then directs the air through a sequential series of air turbines (not shown) rotatably mounted within the gas turbine engine to drive the rotation of the air turbines and one or more compressor stages (also not shown) mechanically coupled thereto. Depending upon the particular design of the gas turbine engine, the air may then be exhausted to provide forward thrust.

A certain volume of the air supplied by diffuser 40 is directed over and around combustor 20. A first portion of this air flows along a first cooling flow path (represented in FIG. 1 by arrows 48) provided between outer liner wall 24 and outer engine casing 14. One or more apertures may be provided through flange 36 so as to not block airflow along cooling flow path 48. A second portion of the air supplied by diffuser flows along a second cooling flow path (represented in FIG. 1 by arrows 50) provided between inner liner wall 22 and inner engine casing 16. Again, one or more apertures may be provided through flange 38 so as to not block airflow along cooling flow path 50. During combustion, the components of combustion section 10 located near combustion chamber 30, especially inner liner wall 22 and outer liner wall 24, are heated by the combustive gases produced within and exhausted from combustion chamber 30; e.g., combustion temperatures within combustion chamber 30 may approach or exceed 4000° Fahrenheit. Airflow along cooling flow paths 48 and 50 is utilized to convectively cool outer liner wall 24 and inner liner wall 22. In a general sense, three different classes of convective cooling may be employed: (i) film cooling wherein airflow is directed over, and generally flows along, the inner surface and/or the outer surface of liner walls 22 and 24; (ii) effusion cooling wherein airflow is directed through, and convectively cools the interior of, liner walls 22 and 24; and (iii) impingement cooling wherein high velocity airflow is directed against, impacts, and disperses over the surfaces of liner walls 22 and 24.

By reducing the heating of liner walls 22 and 24, combustor 20 may be operated at higher combustion temperatures and the overall performance of the gas turbine engine can be increased. Therefore, to help reduce the heating of liner walls 22 and 24, liner walls 22 and 24 may each comprise a hybrid structure, namely, a main wall and a thermally-insulative coating. In addition, liner walls 22 and 24 may each include a plurality of impingement and/or effusion channels therethrough to increase cooling efficiency. The following will describe two examples of cooled hybrid structures that are suitable for utilization as inner liner wall 22 and/or outer liner wall 24. Notably, the below-described exemplary embodiments of the cooled hybrid structure provide highly efficient cooling and are less prone to heat-induced structural break-down (e.g., thermomechanical fatigue, creep, oxidation, etc.). Consequently, when employed as a combustor turbine wall, the cooled hybrid structures may increase the operational lifespan of the combustor. Furthermore, in contrast to certain combustor walls formed from conventional materials (e.g., silicon carbide), the below-described exemplary embodiments are relatively lightweight and provide high environmental durability without the need for specialized environmental coatings.

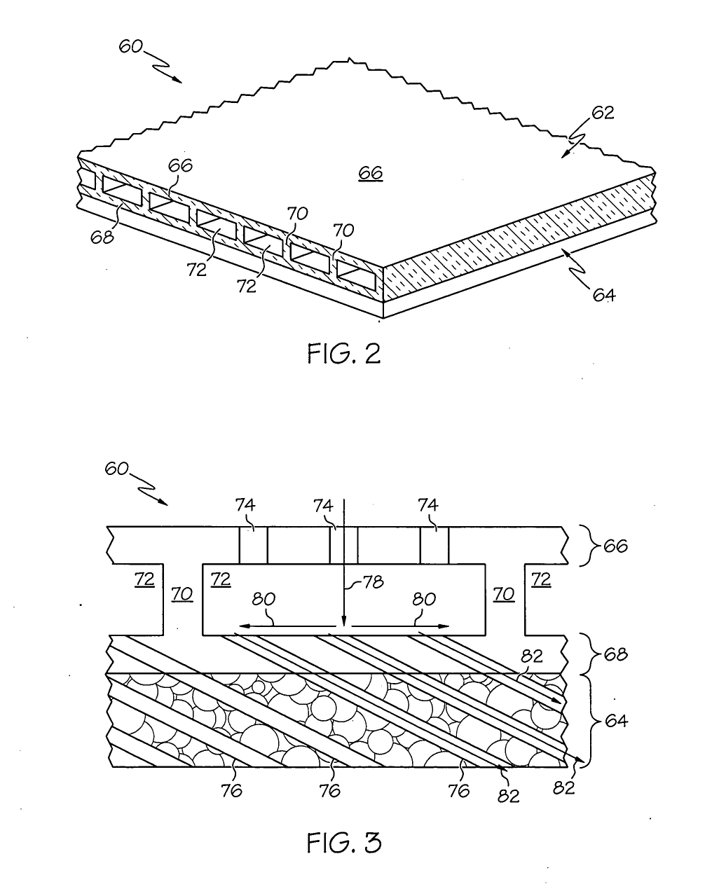

FIG. 2 is a cross-sectional isometric view of a cooled hybrid structure 60 in accordance with a first exemplary embodiment and suitable for utilization as inner liner wall 22 and/or outer liner wall 24 of combustor 20 (FIG. 1). Cooled hybrid structure 60 includes two main components: (i) a woven oxide fiber sheet 62, and (ii) an insulative oxide coating 64. Woven oxide fiber sheet 62, in turn, includes a first main wall 66, a second main wall 68, and a plurality of spacer walls 70. When cooled hybrid structure 60 is employed within a gas turbine engine, second main wall 68 resides closer to the hot gas flow than does first main wall 66 and will consequently be heated to higher temperatures than will first main wall 66 during combustion. For this reason, first main wall 66 and second main wall 68 will be referred to herein as “outer cold wall 66” and as “inner hot wall 68,” respectively. This terminology is utilized as a convenient reference means only and not by way of limitation. This terminology is not intended to convey that inner hot wall 68 will always be hotter than outer cold wall 66; indeed, during periods of GTE inactivity, the temperatures of inner hot wall 68 and outer cold wall 66 may be substantially equivalent.

In the exemplary embodiment illustrated in FIG. 2, outer cold wall 66 and inner hot wall 68 are generally parallel. Outer cold wall 66 and inner hot wall 68 do not directly contact one another; instead, outer cold wall 66 and inner hot wall 68 are joined via spacer walls 70, which extend between outer cold wall 66 and inner hot wall 68. Preferably, outer cold wall 66, inner hot wall 68, and spacer walls 70 are woven together as a single, unitary body. That is, in a preferred method of fabricating woven oxide fiber sheet 62, outer cold wall 66, inner hot wall 68, and spacer walls 70 are collectively formed by interweaving a plurality of oxide fibers. The oxide fibers conveniently comprise at least one ceramic material and preferably comprise an aluminum oxide (also commonly referred to as “alumina”). As a non-limiting example, woven oxide fiber sheet 62 may be formed utilizing 720A oxide fibers.

Insulative oxide coating 64 is disposed over the major inner surface of woven oxide fiber sheet 62 and, more specifically, over the major inner surface of inner hot wall 68. Insulative oxide coating 64 is preferably bonded directly to the inner major surface of inner hot wall 68; e.g., insulative oxide coating 64 may be manually applied over inner hot wall 68 by a technician utilizing a trowel or other tool and subsequently bonded to inner hot wall 68 via a casting process. In a preferred group of embodiments, insulative oxide coating 64 is formed, at least partially, from a material having thermal characteristics (e.g., a co-efficient of thermal expansion) similar to the thermal characteristics (e.g., the co-efficient of thermal expansion) of woven oxide fiber sheet 62. More specifically, it is preferred that the co-efficient of thermal expansion of insulative oxide coating 64 differs from the co-efficient of thermal expansion of woven oxide fiber sheet 62 by less than approximately 10%, as taken over the operative temperature range of combustor 20 (FIG. 1). In certain embodiments, insulative oxide coating 64 may comprise a base material that is identical to or similar to the base material from which woven oxide fiber sheet 62 is formed. In this case, and as generally illustrated in FIG. 3 (described below), the aluminum oxide may be formed into a number of hollow spheres, which are bonded together to form a matrix utilizing a chosen binder. In one preferred group of embodiments, woven oxide fiber sheet 62 comprises at least 50% aluminum oxide by total weight of the woven oxide fiber sheet; and insulative oxide coating 64 comprises at least 50% aluminum oxide by total weight of the insulative oxide coating.

Referring still to FIG. 2, outer cold wall 66, inner hot wall 68, and spacer walls 70 collectively define a plurality of elongated cooling channels 72 within woven oxide fiber sheet 62. Elongated cooling channels 72 reside between outer cold wall 66 and inner hot wall 68 and are generally interspersed with spacer walls 70. Elongated cooling channels 72 may run generally parallel with the longitudinal axis of combustor 20 (FIG. 1). Alternatively, elongated cooling channels 72 may be circumferentially disposed around combustor 20 (FIG. 1). Elongated cooling channels 72 may be blind or may instead be open at either, or both, terminal ends. In the illustrated example, elongated cooling channels 72 extend substantially parallel to one another and each have a generally rectangular cross-sectional geometry; however, the disposition and shape of elongated cooling channels 72 will inevitably vary amongst different embodiments of the present invention. Elongated cooling channels 72 cooperate with a plurality of impingement apertures and a plurality of effusion channels provided through cooled hybrid structure 60 (shown in FIG. 3) to provide highly efficient convective cooling of structure 60 as described more fully below.

FIG. 3 is a simplified cross-sectional view of cooled hybrid structure 60. In this view, it can be seen that cooled hybrid structure 60 further includes a plurality of impingement apertures 74 provided through outer cold wall 66, and a plurality of effusion channels 76 provided through inner hot wall 68 and insulative oxide coating 64. As indicated in FIG. 3 by arrow 78, impingement apertures 74 direct relatively cool airflow through outer cold wall 66 and against an outer surface of inner hot wall 68. Upon impingement with inner hot wall 68, the airflow disperses across the face of inner hot wall 68 (indicated in FIG. 3 by arrows 80) to provide highly effective impingement cooling of inner hot wall 68 and, more generally, of cooled hybrid structure 60. In a preferred group of embodiments, impingement apertures 74 are formed to be substantially orthogonal to outer cold wall 66 to maximize the velocity of airflow through apertures 74 and, therefore, the convective cooling of inner hot wall 68. Impingement aperture 74 may be formed utilizing a laser drilling process, a mechanical drilling process, a water drilling process, or other suitable technique. As a non-limiting example, each impingement aperture may be formed to have an inner diameter of approximately 0.5 to approximately 1.5 millimeters.

As indicated in FIG. 3 by arrows 82, effusion channels 76 conduct the relatively cool air from elongated cooling channels 72, through inner hot wall 68, through insulative oxide coating 64, and into the heated interior of cooled hybrid structure 60. As air flows through effusion channels 76, the relatively cool air convectively cools the interior of inner hot wall 68 and insulative oxide coating 64. In addition, airflow expelled from effusion channels 76 may help create a cooling film along the inner surface of insulative oxide coating 64 (again, the term “inner” is utilized with reference to the origin of combustion and the direction of hot gas flow). To increase the length of effusion channels 76 and, therefore, the surface area available for convective cooling, it is generally preferred that effusion channels 76 are formed through inner hot wall 68 and insulative oxide coating 64 at an acute angle. As are impingement apertures 74, effusion cooling channels 76 may be formed utilizing a laser drilling process, a mechanical drilling process, a water drilling process, or other suitable technique. As a non-limiting example, effusion channels 76 may each be formed to have an inner diameter of approximately 0.5 to approximately 1.5 millimeters.

Elongated cooling channels 72, impingement apertures 74, and effusion channels 76 cooperate to provide highly effective air cooling of cooled hybrid structure 60. As a result, when cooled hybrid structure 60 is employed as a combustor liner wall (e.g., as liner wall 22 and/or as liner wall 24 shown in FIG. 1), insulative oxide coating 64 may be formed from lightweight ceramic materials, such as aluminum oxide, having temperature break-down thresholds significantly less than peak combustion temperatures. By increasing the effectiveness of convective cooling, cooled hybrid structure 60 also helps reduce the temperature gradient across structure 60, which, in turn, reduces thermomechanical fatigue that may occur during combustion due to relative movement between insulative oxide coating 64, inner hot wall 68, and outer cold wall 66. In embodiments wherein insulative oxide coating 64 and woven oxide fiber sheet 62 materials having similar co-efficients of thermal expansion (e.g., in embodiments wherein coating 64 and fiber sheet 62 both comprise aluminum oxide), relative movement between insulative oxide coating 64 and woven oxide fiber sheet 62 is further reduced. Notably, relative to certain known materials (e.g., silicon carbide) conventionally utilized to form combustor liner walls, the above-described oxides, and specifically aluminum oxide, is relatively lightweight and provides high environmental durability. The woven structure of fiber sheet 62 also provides superior structural strength and durability.

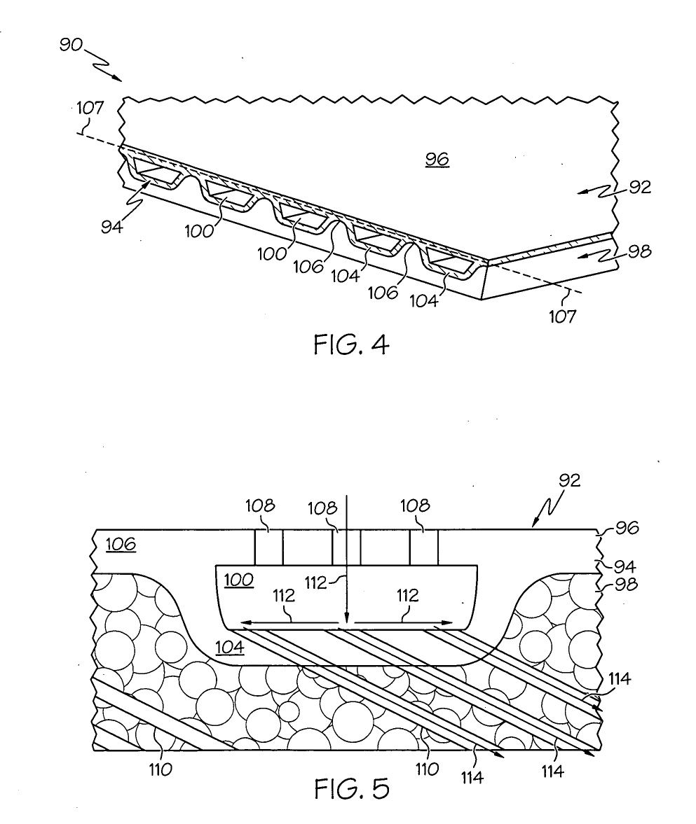

As explained above, cooled hybrid structure 60 greatly reduces internal thermomechanical stressors by providing efficient cooling and, in certain embodiments, by generally matching the co-efficient of thermal expansion of insulative oxide coating 64 with that of woven oxide fiber sheet 62. This notwithstanding, a certain amount of thermomechanical stress may still occur within woven oxide fiber sheet 62 due to relative movement between inner hot wall 68, which may become relatively hot during combustion, and outer cold wall 66, which may remain relatively cool during combustion. For this reason, the cold outer wall and the hot inner wall of the cooled hybrid structure may be directly connected in alternative embodiments. Further emphasizing this point, FIG. 4 is a cross-sectional isometric view of a cooled hybrid structure 90 in accordance with a second exemplary embodiment. In many respects, cooled hybrid structure 90 is similar to cooled hybrid structure 60 (FIGS. 2 and 3). For example, cooled hybrid structure 90 includes: (i) a woven oxide fiber sheet 92 having an inner hot wall 94 and an outer cold wall 96, and (ii) an insulative oxide coating 98 overlaying (e.g., bonded to) the major inner surface of inner hot wall 94. A plurality of elongated cooling channels 100 generally defined by inner hot wall 94 and outer cold wall 96 and extending within woven oxide fiber sheet 92. As previously indicated, woven oxide fiber sheet 92 is preferably formed from plurality of ceramic fibers (e.g., aluminum oxide fibers), which are integrally woven together to form inner hot wall 94 and outer cold wall 96. Insulative oxide coating 98 is conveniently formed to have a co-efficient of thermal expansion similar to that of woven oxide fiber sheet 92 and preferably comprises the same or a similar base material as does woven oxide fiber sheet 92; e.g., in embodiments wherein woven oxide fiber sheet 92 is formed from aluminum oxide fibers, insulative oxide coating 98 may comprise a matrix of aluminum oxide spheres as described above.

In contrast to cooled hybrid structure 60 (FIGS. 2 and 3), inner hot wall 94 and outer cold wall 96 of cooled hybrid structure 90 are not substantially parallel; instead, inner hot wall 94 has a corrugated or undulating geometry and intersects outer cold wall 96 at multiple joinder locations. Stated differently, inner hot wall 94 includes a plurality of raised portions 104 extending away from outer cold wall 96, and a plurality of recesses 106 contacting (e.g., generally contiguous with) outer cold wall 96. The separation between inner hot wall 94 and of outer cold wall 96 proximate recesses 106 is generally indicated in FIG. 4 by dashed line 107, although it will be appreciated that this separation is largely conceptual as inner hot wall 94 is integrally woven with outer cold wall 96. Each elongated cooling channel 100 extends within a different raised portion 104, and insulative oxide coating 98 extends between neighboring raised portions 104 to generally fill recesses 106. As a result of this structural arrangement, the temperature of inner hot wall 94 remains relatively close to the temperature of outer cold wall 96 proximate recesses 106 thus reducing heat-induced displacement between inner hot wall 94 and outer cold wall 96 and, therefore, thermomechanical stressors within woven oxide fiber sheet 92.

FIG. 5 is a simplified cross-sectional view of cooled hybrid structure 90 illustrating airflow therethrough. In this view, it can be seen that cooled hybrid structure 90 further includes a plurality of impingent apertures 108 formed through outer cold wall 96, and a plurality of effusion channels 110 formed through raised portions 104 of inner hot wall 94 and through insulative oxide coating 98. As should be gathered from the foregoing description of impingement apertures 74 (FIG. 3), impingement apertures 108 direct relatively cool airflow through outer cold wall 96, impinge upon an outer surface of inner hot wall 94, and disperse along inner hot wall 94 (indicated in FIG. 5 by arrows 112) to provide highly effective impingement cooling. Furthermore, as indicated in FIG. 5 by arrows 114, effusion channels 110 permit relatively cool air to flow from elongated cooling channels 100, through inner hot wall 94, through insulative oxide coating 98, and to the exterior of cooled hybrid structure 90. In this manner, effusion channels 110 permit the interior of inner hot wall 94 and insulative oxide coating 98 to be convectively cooled and facilitate the formation of a cooling film along the inner surface of insulative oxide coating 98. Impingement apertures 108 are preferably formed to be substantially orthogonal to outer cold wall 96 to maximize the airflow velocity through apertures 108 and, therefore, the convective cooling of inner hot wall 94. Effusion channels 110 are preferably formed at an acute angle to increase the length thereof and, therefore, the convective cooling of inner hot wall 94 and insulative oxide coating 98. As noted above, impingement apertures 108 and effusion channels 110 may be formed utilizing various conventional drilling processes.

The foregoing has thus provided two examples of a cooled hybrid structure suitable for deployment within a gas turbine engine as a combustor liner wall or other air-cooled structure. The above-described exemplary embodiments achieve highly efficient cooling and, in so doing, minimize heat-induced structural breakdown (e.g., thermomechanical fatigue, creep, oxidation, etc.) and lengthen operational lifespan. Thermomechanical fatigue is further reduced and operational lifespan is further increased in embodiments wherein both the woven oxide fiber sheet and the insulative oxide coating are formed from the same or similar base materials (e.g., aluminum oxide). Embodiments of the cooled hybrid structure are also relatively lightweight and environmentally durable.

The foregoing has also provided embodiments of a method for fabricating a cooled hybrid structure. In certain ones of the above-described exemplary embodiments, the method includes the steps of: (i) forming a woven oxide fiber sheet having an outer cold wall, an inner hot wall, and a plurality elongated cooling channels extending within the woven oxide fiber sheet; (ii) applying an insulative oxide coating over the inner hot wall; and (iii) drilling (e.g., laser drilling) a plurality of impingement apertures through the outer cold wall and a plurality of effusion channels through the inner hot wall and through the insulative oxide coating. In one option, the step forming comprising interweaving a plurality of aluminum oxide fibers to produce the woven oxide fiber sheet. In a second option, the step of applying comprises casting an insulative aluminum oxide coating onto the inner hot wall. As utilized herein, the term “insulative aluminum oxide coating” denotes a thermally-insulative coating containing at least 50% aluminum oxide by weight of the oxide coating.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A cooled hybrid structure for deployment within a gas turbine engine, the cooled hybrid structure comprising:
a woven oxide fiber sheet, comprising:
an outer cold wall; and
an inner hot wall integrally woven with the outer cold wall and cooperating therewith to define a plurality of elongated cooling channels extending within the woven oxide fiber sheet;
an insulative oxide coating overlaying the inner hot wall;
a plurality of impingement apertures through the outer cold wall and configured to conduct airflow into the plurality of elongated cooling channels and against the inner hot wall to convectively cool the woven oxide fiber sheet; and
a plurality of effusion channels through the inner hot wall and through the insulative oxide coating and configured to conduct airflow through the insulative oxide coating to provide convective cooling thereof.

2. A cooled hybrid structure according to claim 1 wherein the insulative oxide coating is bonded directly to the inner hot wall.

3. A cooled hybrid structure according to claim 1 wherein the woven oxide fiber sheet comprises aluminum oxide fibers.

4. A cooled hybrid structure according to claim 3 wherein the insulative oxide coating comprises aluminum oxide.

5. A cooled hybrid structure according to claim 1 wherein the outer cold wall and the inner hot wall are generally parallel.

6. A cooled hybrid structure according to claim 5 wherein the woven oxide fiber sheet further comprises a plurality of spacer walls between the outer cold wall and the inner hot wall.

7. A cooled hybrid structure according to claim 6 wherein the plurality of spacer walls is interspersed with the plurality of elongated cooling channels.

8. A cooled hybrid structure according to claim 1 wherein the inner hot wall has a generally corrugated geometry.

9. A cooled hybrid structure according to claim 1 wherein the inner hot wall comprises:
a plurality of raised portions extending away from the outer cold wall; and
a plurality of recesses contacting the outer cold wall and interspersed with the plurality of raised portions.

10. A cooled hybrid structure according to claim 9 wherein each elongated cooling channel in the plurality of elongated cooling channels extends within a different raised portion in the plurality of raised portions.

11. A cooled hybrid structure according to claim 10 wherein the insulative oxide coating extends into and substantially fills each of the plurality of recesses.

12. A cooled hybrid structure according to claim 1 wherein the gas turbine engine comprises a combustor, and wherein the cooled hybrid structure comprises a combustor liner wall.

13. A cooled hybrid structure according to claim 12 wherein the co-efficient of thermal expansion of the insulative oxide coating differs from the co-efficient of thermal expansion of the woven oxide fiber sheet by less than 10%, as taken over the operational temperature range of the combustor.

14. A cooled hybrid structure for deployment within a gas turbine engine, the cooled hybrid structure comprising:
a woven oxide fiber sheet, comprising:
an outer cold wall; and
an inner hot wall integrally woven with the outer cold wall and cooperating therewith to define a plurality of elongated cooling channels extending within the woven oxide fiber sheet;
an insulative oxide coating bonded directly to the inner hot wall;
a plurality of impingement apertures through the outer cold wall and configured to conduct airflow into the plurality of elongated cooling channels and against the inner hot wall to convectively cool the woven oxide fiber sheet; and
a plurality of effusion channels through the inner hot wall and through the insulative oxide coating and configured to conduct airflow through the insulative oxide coating to provide convective cooling thereof;
wherein the woven oxide fiber sheet and the insulative oxide coating each comprise aluminum oxide.

15. A cooled hybrid structure according to claim 14 wherein the woven oxide fiber sheet comprises at least 50% aluminum oxide by total weight of the woven oxide fiber sheet, and wherein the insulative oxide coating comprises at least 50% aluminum oxide by total weight of the insulative oxide coating.

16. A cooled hybrid structure according to claim 15 wherein the woven oxide fiber sheet further comprises a plurality of spacer walls extending between the outer cold wall and the inner cold wall and interspersed with the plurality of elongated cooling channels.

17. A cooled hybrid structure according to claim 15 wherein the inner hot wall comprises:
a plurality of raised portions extending away from the outer cold wall, each elongated cooling channel in the plurality of elongated cooling channels extending within a different raised portion in the plurality of raised portions; and
a plurality of recesses interspersed with the plurality of raised portions and contacting the outer cold wall, each recess in the plurality of recesses generally being filled by the insulative oxide coating.

18. A method for fabricating a cooled hybrid structure for deployment within a gas turbine engine, the method comprising:
forming a woven oxide fiber sheet having an outer cold wall, an inner hot wall, and a plurality elongated cooling channels extending within the woven oxide fiber sheet;
applying an insulative oxide coating over the inner hot wall; and
drilling: (i) a plurality of impingement apertures through the outer cold wall, the plurality of impingement apertures configured to conduct airflow into the plurality of elongated cooling channels and against the inner hot wall to convectively cool the woven oxide fiber sheet; and (ii) a plurality of effusion channels through the inner hot wall and through the insulative oxide coating, the plurality of effusion channels configured to conduct airflow through the insulative oxide coating to provide convective cooling thereof.

19. A method according to claim 18 wherein the step of forming comprises interweaving a plurality of aluminum oxide fibers to produce the woven oxide fiber sheet.

20. A method according to claim 19 wherein the step of applying comprises casting an insulative aluminum oxide coating onto the inner hot wall.
